(19) United States
(12) Patent Application Publication
(10) Pub. No.: US 2025/0322357 A1
(43) Pub. Date: Oct. 16, 2025

(54) EVENT NOTIFIER

(71) Applicant: Wells Fargo Bank, N.A., San Francisco, CA (US)

(72) Inventors: Jasmine Barnes, Mooresville, NC (US); Anantharaman Kendapadi, Charlotte, NC (US); Rameshchandra Bhaskar Ketharaju, Hyderabad (IN)

(21) Appl. No.: 18/637,249

(22) Filed: Apr. 16, 2024

(51) Int. Cl. G06Q 10/10

(52) U.S. Cl. CPC G06Q 10/10

(57) ABSTRACT

An example method for updating users regarding incidents includes: receiving, by a computing system, one or more reports of one or more incidents; generating, by the computing system, information about each of the one or more reported incidents based on the one or more reports received by the computing system; distributing to one or more user devices the information about the one or more reported incidents; and continually updating the information distributed to the one or more of the plurality of user devices. The information can be distributed as an events ticker, which can be associated with a software application, such as a messaging application, so that the ticker may scroll events while the user is using the messaging application.

### BACKGROUND

Organizations have needs for effective monitoring and reporting of incidents, or events, that potentially impact the organizations' operations and wellbeing. For example, when a fire breaks out at an organization's facility, information about the fire, such as its location, nature, severity, and casualty need to be timely reported to the relevant people within the organization and outside the organization.

### SUMMARY

This disclosure relates to notification of events surrounding an organization. In some embodiments, notification of such events is provided in the form of a ticker that updates as information is provided to it relating to events. In some embodiments, the events ticker is pushed to users within a messaging application on a computing device and scrolls through relevant events so that the user can be kept up to date.

In one example, the events ticker is incorporated into a messaging application, such as Microsoft Teams. The events ticker scrolls events information for users of Teams. The events ticker is fed information from a computing system running a multimodal foundation model that consumes information from a variety of sources.

For instance, data from multiple sources is fed to the multimodal foundation model. This includes event records from an enterprise resiliency database, text/photo/video/audio submissions from employees and subsidiaries, temperature, moisture, fire and air pressure signals from IoT sensors, communications received from property managers, etc. The multimodal foundation model is fine-tuned (for example, trained by machine learning) to generate text descriptions of the events and the potential threats associated with the events based on the inputs received from the data sources. In some embodiments, in addition to the text description, it is prompted to generate messages classifying the threats.

In some embodiments, the output of the multimodal foundation model is fed to a distribution module. The distribution module has various settings and rules to control the distribution of threat descriptions. It maintains a list of locations and a list of roles. Based on the settings and rules, the threat descriptions are distributed to the ticker displays. The distributions may be based on the location of the ticker display or the screen display, or, in case of the screen display, it can be based on the role of the person who is viewing the screen.

### DESCRIPTION OF THE DRAWINGS

FIG. 1 shows an example system for reporting and notification of events relating to an organization.

FIG. 2 shows example process for reporting and notification of events relating to the organization of FIG. 1.

FIG. 3 shows a logic block diagram of the event reporting and notification system of FIG. 1.

FIG. 4 shows example physical components of the event reporting and notification of the system of FIG. 1.

### DETAILED DESCRIPTION

This disclosure relates to reporting incidents, or events, that potentially impact the interests of an organization, and notifying relevant persons of such incidents and/or the potential impact of such incidents on the organization.

Certain examples provided in this disclosure facilitate automated, timely notifications to relevant personnel of an organization of the occurrences and updates incidents that may have significant impact on the organization. The computer systems in certain embodiments accept incident reports in a variety of modalities, among which are text, pictorial images, videos and audio. The computer system, using trained multimodal foundation models in some embodiments, can classify the reported incidents (e.g., natural disasters, equipment malfunctions, etc.) and provide textual description of the incidents. The computer system in some embodiments can further assess potential impacts of the reported incidents and provide suggestions on resolving issues raised by the reported incidents. The computer systems in some embodiments further include distribution systems, with rules and settings that ensure appropriate personnel are notified of any reported incidents. The notification in some embodiments are sent as events tickers displayed on the recipients' screens when the recipients are using certain software applications, such as messaging applications.

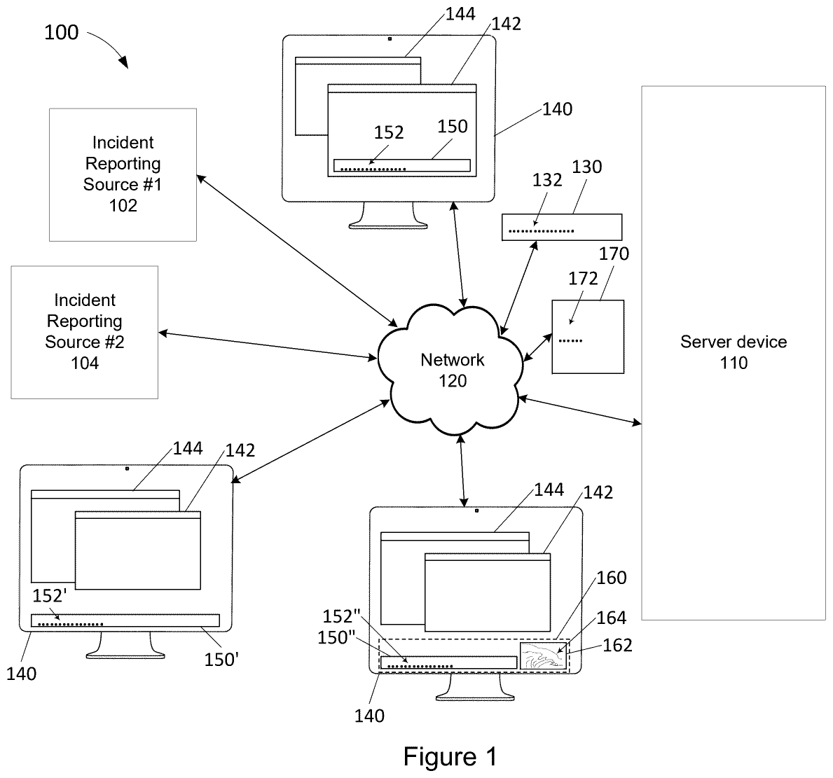

An example system 100 for incident reporting the notification according to some embodiments is schematically shown in FIG. 1. The system 100 includes one or more incident reporting sources, for example, the first source 102 and second source 104. Reporting sources can be any source of information relating to an incident. For example, such source can include records from an enterprise resiliency database; text, photo, video or audio submissions from employees and subsidiaries of the organization and from automated recording system devices, such as surveillance cameras; temperature, moisture, fire and air pressure signals from sensors, such as Internet-of-Things (“IoT”) sensors; and communications received from property managers. Any suitable device can be used to transmit the information relating to the incidents to be reported. For example, controllers or processors, such as micro processors used to collect signals from sensors, computers running the databases, computers running email or texting applications, telephones, including smartphones capable of taking text inputs, photo, videos, and sound recordings, and transmitting such information through wired connections and/or wireless connections.

The system 100 in this example includes a computing device, such as a server device 110 of FIG. 1, which is configured to receive the incidents, process the information, and notify the appropriate uses of the incidents. The information relating to the incidents being reported can be sent from the incident reporting sources 102, 104 through direct links, wired or wireless, or, as illustrated in FIG. 1, via one or more networks 120, which can be any network, including the Internet, local-area networks (LANs), and wired or wireless networks internal to the organizations.

The server device 110 in this example is also connected to various user devices for notifying the users of those devices of at least some of the incidents reported by the incident reporting sources 102, 104. The connections can be direct, wired or wireless links or, as illustrated in FIG. 1, via one or more networks, such as the network 120 through which incident information is transmitted from the sources 102, 104 to the service device 110.

The user devices can be any device configured to receive information from the server device 110 and convey the received information to the respective users of the devices. The information can be conveyed to the user in any suitable manner. In the example illustrated in FIG. 1, the information is conveyed visually, but can be conveyed in other manners, including through audio and/or tactile means.

In some embodiments, the server device is configured to continually process the incoming incident information and push the processed information to the user devices substantially in real time. Alternatively, the user devices are configured to continually interrogate the server device 110 for updated processed information. In some embodiments, the user devices are configured to continually display (or convey to the users by other means) the information as it is received by the user devices so that the user can be kept up to date. In some embodiments, the information is conveyed to users in the form of an events ticker that scroll through relevant events on the user devices.

Examples of user devices include, as illustrated in FIG. 1, ticker displays 130, screen displays, such as computer screen displays 140 and smartphone displays, and customer displays 170. On a ticker display 130, the events ticker 132 can be a continually scrolling text. On a screen display, an events ticker 152 can be displayed in an events ticker area 150. An events ticker area 150 can be programmed to be associated with a specific computer application and be displayed when the user interface of that application is running in an active window 142. The computer application needs not be related to any event any user is being notified of through the ticker. In one example, the events ticker is incorporated into a messaging application, such as Microsoft Teams. The events ticker scrolls events information for the appropriate users of Teams so that those users are updated, while participating in Teams meetings, on events that may concern them. In further embodiments, an events ticker area is programmed to be always associated with the active window 142 so that the events ticker always scrolls events information in program that is running in the foreground, regardless of what that program is and not be running in any inactive window 144.

In a still further embodiments, an events ticker area 150′, which displays the events ticker 152′, is programmed to be positioned in a specific area (e.g., bottom or top) of the screen display 140, independent of the windows 142, 144. In other examples, an events ticker area 150″, which displays the events ticker 152″, is positioned within an events update area 160 which, in the example in FIG. 1, also includes a graphical information area 162, which displays graphical (photo or video) information 164 relating to the events ticker 152″ being scrolled in the events ticker area 150″. The events ticker 172 can be displayed in the customer display 170 in any manner suitable for conveying events information using the customer display 170.

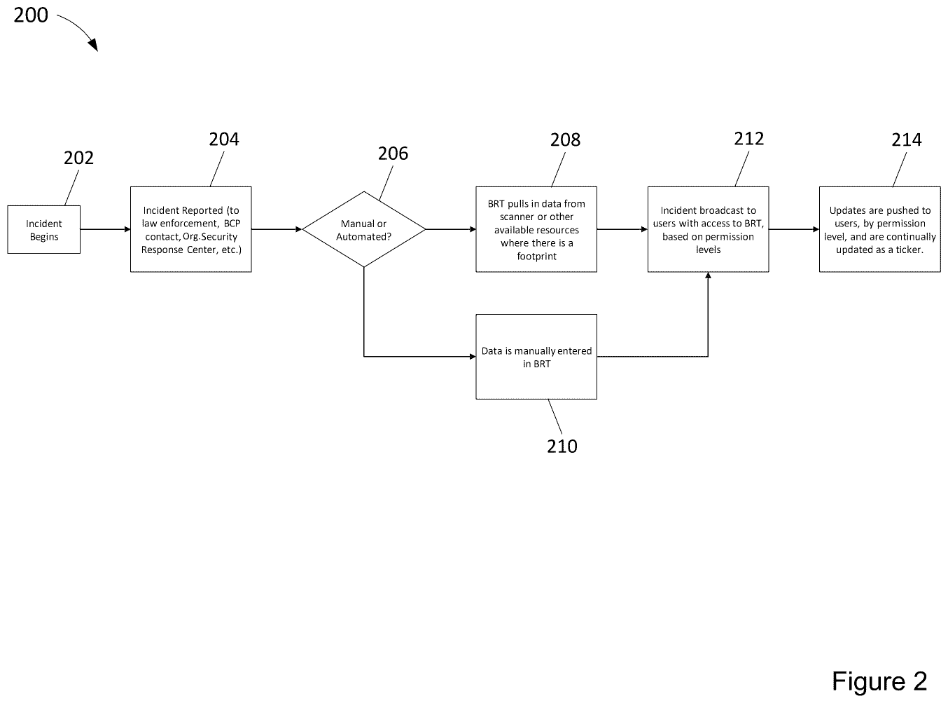

An example process 200 for reporting and notification of incidents as performed by the system 100 is outlined in FIG. 2. In this example, the process 200 begins with the occurrence 202 of an incident, and a determination is made 204 regarding the organizational groups to which the incident is to be reported. Such organization group can include, for example, the law enforcement authorities, business continuity planning (“BCP”) contact, and organization security response center. Next, a determination is made 206 as to whether the incident is to be reported manually or in an automated process. If the incident is to be reported in an automated process, a business resiliency tool (“BRT”) implemented by the server device 110, described later in this disclosure, automatically gathers 208 the data, for example from scanners monitoring radio (e.g., police/fire radio) traffic, IoT sensors, or other resources to which the BRT has access. If an incident is to be reported manually, incident data is entered manually 210. For example, an incident can be manually reported by an employee of the organization or a subsidiary can report an incident by texting.

The reported incident is then broadcast 212, by the server device 110, to appropriate users of the BRT based on various factors, including the required permission level for accessing the report. Other factors, such as location (e.g., proximity to the location of the incident or to resources needed to resolve issues raised by the incident) and the role a potential recipient of the incident information plays in the organization or potentially in resolving issues raised by the incident. Furthermore, updates, both of the incident and of any new incident, are continually pushed 214 to the users according to the criteria described above. In some embodiments, an unresolved incident can be continually pushed to the appropriate users. In some embodiments, a time stamp, such as a time stamp of the latest report received on an incident, can be included in the pushed data so that the user receiving the pushed data is aware the age of pushed data. As described above, the pushed data can be displayed as an events ticker.

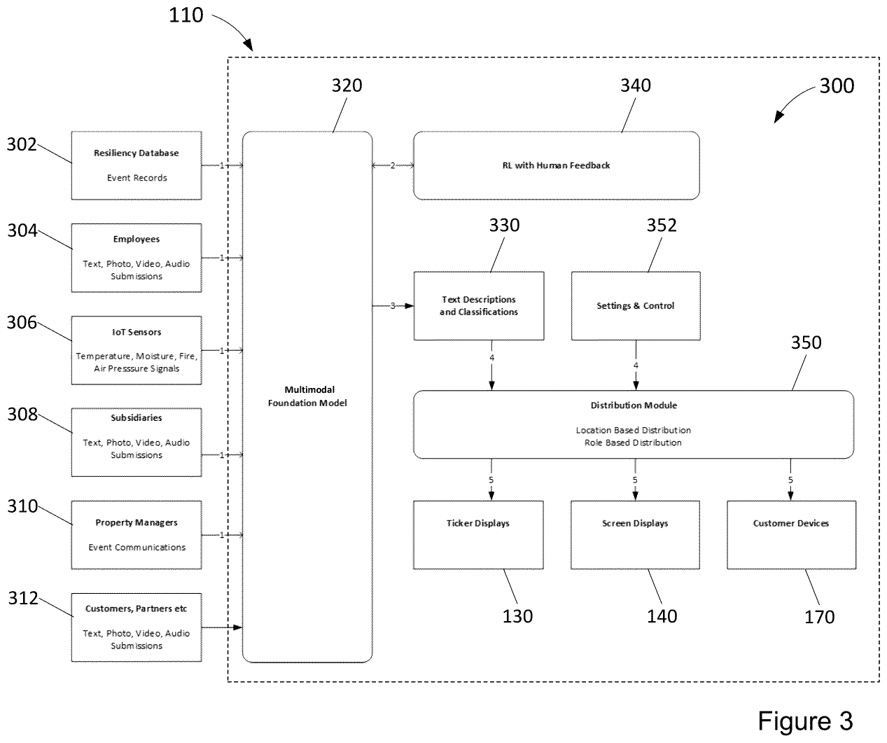

The logical structure of an example BRT, which is a component of the server device 110, that can be used to carry out the incident reporting and notification process is shown in FIG. 3. In this example, the BRT 300 continually monitor available incident reporting sources and accepts reports from multiple incident reporting sources in a variety of modalities, including a resiliency database 302, which includes records of events, such as event logs; employee-based sources 304, such as text, photographic, videographic, and audio submissions; IoT sensors 306, such as temperature and moisture sensors, fire detectors, and air pressure sensors; subsidiary-based sources 308, such as text, photographic, videographic, and audio submissions; property-manager-based sources 310, such as verbal and written communications regarding incidents; and customer- or partner-based sources 312, such as text, photographic, videographic, and audio submissions.

The BRT 300 in this example includes a computing device running a multimodal foundation model 320, which receives incident report from the reporting source mentioned above, and outputs 330 text descriptions and, optionally, classifications, of the reported incidents. Optionally or alternatively, the multimodal foundation model can also output graphic descriptions, such as icons, modified photographs or videos, as well as other types of information, such as suggested responses (not shown in the drawings). A multimodal foundation model is an artificial intelligence (“AI”) model trained on broad data and thus can be adapted to a wide range of downstream tasks, with the capability to deal with a variety of input modalities, including vision and vision-language modalities.

In the example shown in FIG. 3, the multimodal foundation model is fine-tuned, or trained, using, for example machine learning, including reinforcement learning (“RL”) 340, with human feedback. In some embodiments, the trained model is capable of generating appropriate textual descriptions of reported incidents. For example, in some embodiments, the model can be capable of generating textual descriptions, including attributes, such as a classification of the incident (i.e., fire) and location, of a reported fire based on a submitted pictorial image, such as a photograph, of the fire and the location information from the metadata of the photograph. Furthermore, in some embodiments, the model can provide information on a proper response to the incident based on the training data. The model in some embodiments is further capable of generating description of potential threats or impact on the organization based on the inputs received from the data sources. In addition to the text description, the model is capable of generating classifications of threats and/or impacts.

The BRT 300 in this example further includes a distribution module 350. The distribution module 350 is provided 352 with various settings and rules to control the distribution of incident and threat descriptions. It maintains a list of locations and a list of roles. Based on the information received from the multimodal foundation model 320, the settings and rules, the incident and threat descriptions are distributed to the ticker displays. The distributions may be based on the location of the ticker display or the screen display, or, in case of the screen display, it can be based on the role of the person who is viewing the screen. In some cases, where the incident description (classification, location) does not result in the identification of an appropriate user for notification based on the description, a default person may be notified based on the settings and rules of the distribution module so that any reported incident is brought to the attention of at least some person. As described above, the targets of distribution can include ticker displays 130, screen displays 140, and customer displays 170.

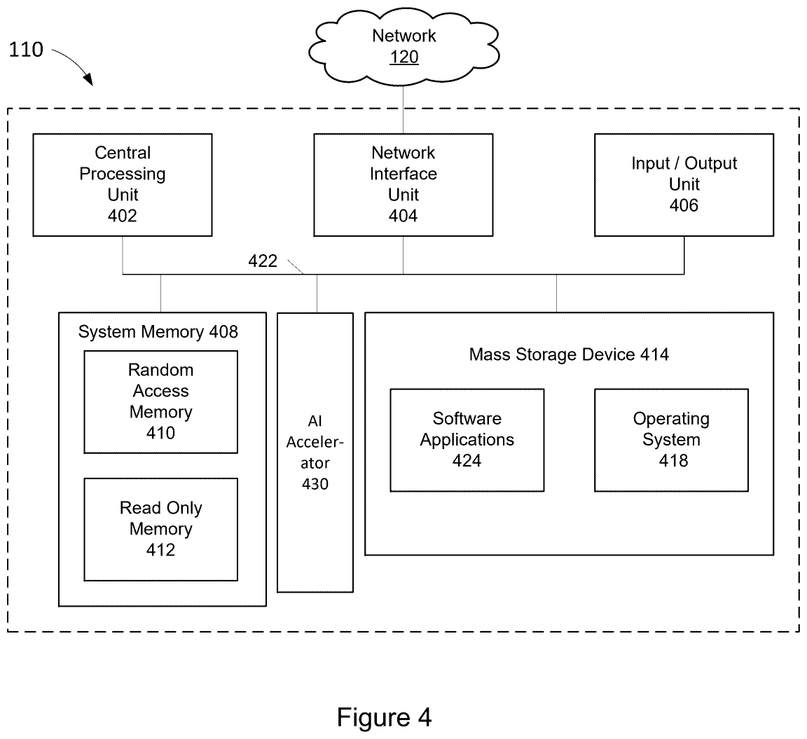

In some embodiments, the logic structure described above, including the multimodal foundation model and distribution module, is implemented by one or more computers, such as the server device 110. In some embodiments, as illustrated in the example shown in FIG. 4, the example server device 110 includes at least one central processing unit (“CPU”) 402, a system memory 408, and a system bus 422 that couples the system memory 408 to the CPU 402. The system memory 408 includes a random-access memory (“RAM”) 410 and a read-only memory (“ROM”) 412. A basic input/output unit system, containing the basic routines that handle certain tasks, such as startup, is stored in the ROM 412. The service device 110 can further include an artificial intelligence (“AI”) processing unit, such as an AI accelerator 430, directly connected to the CPU or connected to the CPU through the system bus 422. The AI accelerator in some embodiments includes one or more memory arrays and associated circuitry that are configured as artificial neural networks that are especially suited for executing a large number of certain types of computations, such as multiply-accumulate (“MAC”) at the memory level with limited intervention from the CPU. The AI accelerator 430 can thus carry out AI computations at high speeds and can be well suited for implementing AI models such as multimodal foundation model. The server device 110 further includes a mass storage device 414. The mass storage device 414 can store software instructions and data.

The mass storage device 414 is connected to the CPU 402 through a mass storage controller (not shown) connected to the system bus 422. The mass storage device 414 and its associated computer-readable data storage media provide non-volatile, non-transitory storage for the service device 110. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 110.

According to various embodiments of the invention, the server device 110 can operate in a networked environment using logical connections to remote network devices through network 120, such as a wireless network, the Internet, or another type of network. The server device 110 may connect to network 120 through a network interface unit 404 connected to the system bus 422. It should be appreciated that the network interface unit 404 may also be utilized to connect to other types of networks and remote computing systems. The server device 110 also includes an input/output controller 406 for receiving and processing input from a number of other devices, including a user interface display screen or another type of input device. Similarly, the input/output controller 406 may provide output to a user interface display screen or other output devices.

As mentioned briefly above, the mass storage device 414 and the RAM 410 of the server device 110 can store software instructions and data. The software instructions include an operating system 418 suitable for controlling the operation of the server device 110. The mass storage device 414 and/or the RAM 410 also store software instructions and applications 424, that when executed by the CPU 402, causes the server device 110 to provide the functionality of the server device 110 discussed in this disclosure.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for updating users regarding incidents for an organization, the method comprising:
receiving, by a computing system, one or more reports of one or more incidents relating to the organization;
generating, by the computing system, information about each of the one or more incidents based on the one or more reports received by the computing system;
distributing, via an events ticker, to one or more of a plurality of user devices the information about the one or more incidents; and
continually updating the information distributed to the one or more of the plurality of user devices.

2. The method of claim 1, wherein at least a subset of the plurality of user devices are visual display devices, and the distributing the information comprises causing the visual display devices to display the events ticker.

3. The method of claim 2, wherein at least a subset of the visual display devices each comprise a screen display, and wherein the causing the visual display devices to display the events ticker comprises maintaining a display of the events ticker in a display area located in a screen area on the screen display, the screen area being associated with an active user interface area for a predetermined software application.

4. The method of claim 3, wherein the predetermined software application comprises a messaging application.

5. The method of claim 1, wherein receiving the one or more reports comprises receiving a plurality of incident reports in a plurality of report modalities, at least two of which are different from each other, and generating the information about each of the one or more incidents comprises generating the information about each of the one or more incidents in the same modality.

6. The method of claim 5, wherein at least one of the plurality of incident reports is in text, and at least another one of the plurality of incident reports is in audio, pictorial, or video formats.

7. The method of claim 6, wherein generating the information about each of the one or more incidents in the same modality comprises generating information about each of the one or more incidents in text.

8. The method of claim 5, wherein generating the information about each of the one or more incidents in the same modality comprises extracting attributes of each of the one or more incidents from a respective one of the incident reports using an artificial intelligence model.

9. The method of claim 8, wherein the extracting attributes of each of the one or more incidents using the artificial intelligence model comprises generating a classification of each of the one or more incidents and generating information about the classification of each of the one or more incidents.

10. The method of claim 8, wherein generating the information about each of the one or more incidents further comprises generating information about implications that of each of the one or more incidents may have for the organization.

11. The method of claim 1, wherein the distributing to one or more of the plurality of user devices the information about the one or more incidents comprises determining at least one attribute of at least one of the one or more incidents and one attribute of a user of at least one of the plurality of user devices, and determining whether to distribute the at least one of the one or more incidents to the user at least in part based on the at least one attribute of the at least one of the one or more incidents and the at least one attribute of the user.

12. The method of claim 1, wherein a user belongs to the organization, wherein the at least one attribute of the at least one of the one or more incidents comprises a location of the respective reported incident, and wherein the at least one attribute of the user comprises the user's role in the organization.

13. An electronic computing device comprising:
a processor; and
system memory, the system memory including instructions which, when executed by the processor, cause the electronic computing device to:
receive, by a computing system, one or more reports of one or more incidents;
generate, by the computing system, information about each of the one or more incidents based on the one or more reports received by the computing system;
distribute, via an events ticker, to one or more of a plurality of user devices the information about the one or more incidents; and
continually update the information distributed to the one or more of the plurality of user devices.

14. The electronic computing device of claim 13, wherein at least a subset of the plurality of user devices are visual display devices, and the distributing the information comprises causing the visual display devices to display the events ticker.

15. The electronic computing device of claim 14, wherein at least a subset of the visual display devices each comprise a screen display, and wherein the causing the visual display devices to display the events ticker comprises maintaining a display of the events ticker in a display area located in a screen area on the screen display, the screen area being associated with an active user interface area for a predetermined software application, where the predetermined software application comprises a messaging application.

16. The electronic computing device of claim 13, wherein receiving the one or more reports comprises receiving a plurality of incident reports in a plurality of report modalities, at least two of which are different from each other, and generating the information about each of the one or more incidents comprises generating information about each of the one or more incidents in the same modality, wherein at least one of the plurality of incident reports is in text, and at least another one of the plurality of incident reports is in audio, pictorial, or video formats.

17. The electronic computing device of claim 16, wherein generating the information about each of the one or more incidents in the same modality comprises classifying each of the one or more incidents and generating the information about each of the one or more incidents.

18. The electronic computing device of claim 17, wherein:
generating the information about each of the one or more incidents further comprises generating the information about implications of each of the one or more incidents may have for an organization;
the distributing to one or more of the plurality of user devices the information about the one or more incidents comprises determining at least one attribute of at least one of the one or more incidents and one attribute of a user of at least one of the plurality of user devices, and determining whether to distribute the at least one of the one or more incidents to the user at least in part based on the at least one attribute of the at least one of the one or more incidents and the at least one attribute of the user; and
the user belongs to the organization, wherein the at least one attribute of the at least one of the one or more incidents comprises a location of the respective reported incident, and wherein the at least one attribute of the user comprises the user's role in the organization.

19. An organizational resiliency system, comprising:
a processing unit, comprising at least a central processing unit (“CPU”);
an input interface configured to receive reports of incidents in a plurality of modalities; and
a distribution module;
the processing unit being configured to generate information about each of the incidents based on the respective one of the reports of incidents received via the input interface, the information about each of the incidents including one or more attributes of the incident and information about implications of the incident may have for an organization;
the distribution module being connected to the processing unit and configured to receive the information generated by the processing unit and to distribute to one or more of a plurality of user devices the information about the one or more incidents, and to continually update the information distributed to the one or more of the plurality of user devices; and
the distribution module further storing distribution rules relating to access to information by users belonging to, and having one or more respective roles within, the organization, and being configured to determine whether to distribute the information about the at least one of the reports of incidents to each of the users at least in part based on at least one attribute of the at least one of the incidents and the one or more respective roles of each of the users.

20. The system of claim 19, wherein the processing unit is configured to implement a trained artificial intelligence model to generate information about each of the incidents based on the respective one of the reports of incidents received via the input interface.
